(19) United States
(12) Patent Application Publication
(10) Pub. No.: US 2006/0090845 A1
(43) Pub. Date: May 4, 2006

(54) Method and system for producing air-packing devices

(76) Inventors: Tateshi Shimowaki, Ama-gun (JP); Hiroshi Takamatsu, Nakashima-gun (JP); Katsutoshi Yoshifusa, Lake Forest, CA (US)

Correspondence Address: MURAMATSU & ASSOCIATES, 114 Pacifica, Suite 310, Irvine, CA, 92618, US

(21) Appl. No.: 10/979,383

(22) Filed: Nov. 2, 2004

(51) Int. Cl. B32B 37/00; B65C 9/25

(52) U.S. Cl. 156/292; 156/323

(57) ABSTRACT

A production method and system is able to produce air-packing device with high efficiency and reliability. The production method is comprised of the steps of: superposing a check valve thermoplastic film on a first air-packing thermoplastic film; bonding the two thermoplastic films for creating a plurality of check valves by heating the thermoplastic films; superposing a second air-packing thermoplastic film on the first air-packing thermoplastic film; and bonding the thermoplastic films by heating the thermoplastic films by a second heater, thereby creating a plurality of air containers each having a check valve. A heat resistant film provided between the thermoplastic films and the heater is moved in a direction opposite to a feeding direction of the thermoplastic films immediately after each bonding step.

### FIELD OF THE INVENTION

This invention relates to a method and system for producing air-packing devices for use as packing materials, and more particularly, to a method and system for producing air-packing devices with high efficiency and reliability using thermoplastic films either including enforcement films or without including enforcement films therein.

### BACKGROUND OF THE INVENTION

In a distribution channel such as product shipping, a packing method using a fluid container containing a liquid or gas such as air (hereafter “air-packing device”) is becoming popular. The air-packing device has excellent characteristics to solve the problems involved in the conventional method. First, because the air-packing device is made of only thin sheets of plastic films, it does not need a large warehouse to store it unless the air-packing device is inflated. Second, a mold is not necessary for its production because of its simple structure. Third, the air-packing device does not produce a chip or dust which may have adverse effects on precision products. Also, recyclable materials can be used for the films forming the air-packing device. Further, the air-packing device can be produced with low cost and transported with low cost.

FIG. 1 shows an example of structure of an air-packing device having a most simple form when inflated by compressed air. An air-packing device 10 includes a plurality of air containers 12 and check valves 14, a guide passage 11 and an air input 15. The air from the air input 15 is supplied to the air containers 12 through the air passage 11 and the check valves 14. The air-packing device 10 is composed of two thermoplastic films which are bonded together at bonding areas. Typically, bonding areas on the thermoplastic films are outer edges 13 and a boundary 16 between two adjacent air containers.

Each air container 12 is provided with a check valve 14 which allows forward air flow and prohibits reverse air flow in the air container. One of the purposes of having multiple air containers with corresponding check valves is to increase the reliability, because each air container is independent from one another. Namely, even if one of the air containers suffers from an air leakage for some reason, the air-packing device can still function as a shock absorber for packing the product because other air containers are intact.

FIG. 2 is a plan view showing an example of detailed structure of the air-packing device such as shown in FIG. 1 in the area of the check valve. Basically, the air-packing device 10 is made of two thermoplastic films (first and second air-packing films) 17a-17b and a check valve thermoplastic film 18. These thermoplastic films are bonded together through a heat-seal process to produce a sheet of air-packing device 10 as shown in FIG. 1. Thus, the films at the edges 13 and boundaries 16 are air-tightly bonded together. Then, although not shown here, after folding the sheet of air-packing device, a post heat-sealing treatment is applied to the air-packing device 10 to create the final form of air-packing device.

FIG. 3 is a schematic diagram showing an example of production apparatus for continuously producing the air-packing devices. A production apparatus 30 is comprised of a film feeding means 31, film conveying rollers 32, a valve heat seal device 33, an up-down roller controller 34, a sensor 39 for feeding the elongated thermoplastic films, a right/left heat-seal (bonding) device 35, a belt conveyer 37 for the right/left heat-seal operation, and an upper/lower heat seal (bonding) device 36.

The up-down roller controller 34 is provided to the production apparatus 30 in order to improve a positioning performance of the check valves. The up-down controller 34 moves rollers 34b in perpendicular (upward or downward) to a production flow direction H in order to precisely adjust the position of the check valves. Also, the belt conveyer 37 is provided to the production apparatus 30 in order to improve a heat seal performance.

In the process shown in FIG. 3, first, the film feeding means 31 supplies check valve film 18, and the air-packing films 17a and 17b to the following stages of the production process. The film conveying rollers 32 at various positions in the manufacturing apparatus 30 guide and send the films forward in the production direction H. Every time each film is advanced by a length equal to one air-packing device, the heat seal steps are performed at a plurality of stages, such as three stages, in the production process.

The first stage of heat-sealing process is conducted by the valve heat-seal device 33. This is the process for forming the structure of the check valves 14 by bonding the check valve film 18 to either one of the first and second air-packing films 17a-17b. The position of the check valves 14 is precisely adjusted by the up-down roller controller 34 having optical sensors 34a.

The second stage of the heat-sealing process is done by using the right-left heat-seal device 35 and the belt conveyer 37 for sealing the outer edges 13 of the air-packing device 10 and boundaries 16 between the adjacent air containers (air cells). This is a main part of the heat-seal process because the areas to be bonded is much larger than other heat-sealing process. The belt conveyer 37 is used to prevent the heat-sealed portions of the films from extending or broken. The belt conveyer 37 has two rollers 37b and a belt 37a made of a high heat resistance film such as a Mylar film or a Teflon film is mounted.

In the heat-seal process, the heat from the heat-seal device 35 is applied indirectly to the thermoplastic films 17ab-18 (first and second air-packing films 17a and 17B and check valve film 18) through the Teflon film of the conveyer belt 37a. Because of the heat, the thermoplastic films 17ab-18 temporarily stick to the Teflon film of the belt 37a immediately after the heat-seal process. If the thermoplastic films 17ab-18 are immediately separated from the Teflon film, because it is not sufficiently cured, the heat-sealed portions of the thermoplastic films 17ab-18 will be deformed or even damaged.

Thus, in the manufacturing apparatus of FIG. 3, rather than immediately separating the Teflon film from the thermoplastic films 17ab-18, the Teflon film 37a moves at the same feeding speed of the thermoplastic films 17ab-18 because of the belt conveyer 37. During this time, the heat seal portions with a high temperature are naturally cured (cooled) while they are temporarily adhered to the Teflon film on the belt 37a. Thus, the thermoplastic films 17ab-18 can be securely separated from the Teflon film at the end of the belt conveyor 37.

The third stage of the sealing process is performed by the upper-lower heat-seal device 36. This is the final heat-seal process in the production process to produce the air-packing device 10 by bonding the films at the heat-seal lands 43 (FIG. 8). The air-packing devices 10 which are produced in the form of one long sheet may be cut to each sheet of air-packing device 10.

The air-packing device 10 produced through the above noted production process and apparatus is folded to form a shape unique to a product to pack therein. Then, the post heat-sealing treatment is applied to the air-packing device 10 to create the final form of air-packing device 10. The air-packing device 10 is inflated by the compressed air before or after loading the product therein.

FIGS. 4A-4D are schematic diagrams for explaining the problems involved in the conventional production method of FIG. 3 incorporating the belt-conveyer. Generally, the heat from the heat-seal device is applied indirectly to the thermoplastic films through a high heat resistant film such as a Teflon film. In the production method of FIG. 3, the belt conveyer 37 with the Teflon film 37a is used for the heat-seal stage to prevent the thermoplastic films from being damaged by acquiring a cooling time. However, the method of FIG. 3 still has a problem as described below with reference to FIG. 4A-4D,

FIG. 4A shows a situation where the heat-seal device 35 presses the thermoplastic films 17ab-18 to bond the thermoplastic films to one another. Suppose the lower heat-seal device 35b is a heater having a heater head, the Teflon film (conveyer belt) 37a is provided between the thermoplastic films 17ab-18 and the heater 35b. When the heat-seal device 35 is released as shown in FIG. 4B, the thermoplastic films 17ab-18 are moved forward. Because the thermoplastic films 17ab-18 are melted during the heat-seal step of FIG. 4A, the thermoplastic films 17ab-18 stick to the Teflon tape 37a at an area ST and travel together.

In FIG. 4C, the thermoplastic films 17ab-18 and the Teflon tape 37a further travel together until the stuck area ST reaches the end of conveyer roller 37b. It is desired that the thermoplastic films 17ab-18 are cooled during this travel time. At the end of the conveyor roller 37b, the thermoplastic films 17ab-18 are pulled forward while the Teflon film 37a is changed its direction and pulled in the opposite direction. Thus, the thermoplastic films 17ab-18 and the Teflon tape 37a are forcibly separated from one another as shown in FIG. 4D.

In the above process for separating the thermoplastic films 17ab-18 from the Teflon film 37a, a large stress is applied to the heat-sealed portions of the thermoplastic films. Suppose a ratio of the force required for separating the thermoplastic films from the Teflon film and the force required for pulling the thermoplastic films forward is 2:8, the total relative force “10” can be applied to the heat-sealed portions of the thermoplastic films, which is too large to securely produce the air-packing devices. To improve the production efficiency, the thermoplastic films 17ab-18 and the Teflon film 37a have to move relatively fast, there is not a sufficient time for the thermoplastic films to sufficiently cure at the end of the conveyer roller 37. Therefore, the heat-sealed portions of the thermoplastic films 17ab-18 are often damaged.

Air-packing devices are becoming more and more popular because of the advantages noted above. There is an increasing need to store and carry precision products or articles which are sensitive to shocks and impacts often involved in shipment of the products. Thus, there is a need of producing air-packing devices with high efficiency and low cost. There is also a need of producing air-packing devices securely and reliably even when using thermoplastic films without including an enforcement film (ex. nylon) therein for reducing the cost.

### SUMMARY OF THE INVENTION

It is, therefore, an object of the present invention to provide a method and system for producing air-packing devices for packing products with high efficiency and high reliability.

It is another object of the present invention to provide a method and system for producing air-packing devices made of thermoplastic films with or without using enforcement (ex. nylon) films with high efficiency and high reliability.

It is a further object of the present invention to provide a system for producing air-packing devices, a size of the system is smaller than a conventional production system which is achieved by eliminating belt conveyers from the system and incorporating a cooler adjacent to a heater at each heat-seal stage.

In one aspect of the present invention, the air-packing device production method is comprised of the steps of: superposing a check valve thermoplastic film on a first air-packing thermoplastic film; bonding the check valve thermoplastic film to the first air-packing thermoplastic film for creating a plurality of check valves by heating the thermoplastic films by a first heater; superposing a second air-packing thermoplastic film on the first air-packing thermoplastic film while sandwiching the check valve thermoplastic film therebetween; and bonding the first air-packing thermoplastic film and the second air-packing thermoplastic film by heating the thermoplastic films by a second heater, thereby creating a plurality of air containers each having a check valve. In the production method, a heat resistant film provided between the thermoplastic films and the heater is moved in a direction opposite to a feeding direction of the thermoplastic films immediately after each bonding step before moving the thermoplastic films forward in the feeding direction.

The step of bonding the two thermoplastic films includes a step of stopping the two thermoplastic films at a predetermined position and pressing the heater on the two thermoplastic films through the heat resistant film. The step of bonding the two thermoplastic films includes a step of stopping the two thermoplastic films at a predetermined position, moving the heater downwardly against the two thermoplastic films through the heat resistant film, and moving the heater upwardly to release the two thermoplastic films after a predetermined heat-seal time.

The step of bonding the two thermoplastic films includes a step of stopping the two thermoplastic films at a predetermined position, moving the heater downwardly against the two thermoplastic films through the heat resistant film, and moving the heater upwardly to release the two thermoplastic films after a predetermined heat-seal time, wherein the heat resistant film is moved in the opposite direction immediately after the heater is moved upwardly.

The heat resistant film is moved in the opposite direction in a degree sufficient to separate the heat resistant film from the thermoplastic films before moving the thermoplastic films in the feeding direction. The heat resistant film is returned to an original position after moving in the opposite direction and separating from the thermoplastic films by moving in the feeding direction.

The production method further includes a step of cooling the thermoplastic films heated in the bonding step performed immediately prior to the cooling step. The step of cooling the thermoplastic films is conducted by a cooler provided adjacent to each heater, where the heater and the cooler are driven in the same direction at the same timing with one another. The method further includes a step of folding the bonded thermoplastic films in a sheet form and bonding the folded thermoplastic films at predetermined points to form a shape of the air-packing device unique to a product to be packed by the air-packing device.

In another aspect of the present invention is a system for producing air-packing devices. The production system is comprised of: means for superposing a check valve thermoplastic film on a first air-packing thermoplastic film; a first heat-seal stage for bonding the check valve thermoplastic film to the first air-packing thermoplastic film for creating a plurality of check valves by heating the thermoplastic films; means for superposing a second air-packing thermoplastic film on the first air-packing thermoplastic film while sandwiching the check valve thermoplastic film therebetween; a second heat-seal stage for bonding the first air-packing thermoplastic film and the second air-packing thermoplastic film by heating the thermoplastic films, thereby creating a plurality of air containers each having a check valve; and a heat resistant film drive mechanism for driving a heat resistant film provided between the thermoplastic films and the heater in a direction opposite to a feeding direction of the thermoplastic films immediately after each bonding step before moving the thermoplastic films forward in the feeding direction.

According to the present invention, the method and system of the present invention is capable of producing the air-packing devices with high efficiency and high reliability. Since the production method and system can minimize the stress to the thermoplastic films during the heat-seal process, air-packing devices made of thermoplastic films with or without using enforcement films can be produced with high efficiency and high reliability. The size of the production system is reduced by eliminating the belt conveyers from the system and incorporating a cooler adjacent to a heater at each heat-seal stage.

### BRIEF DESCRIPTION OF THE DRAWINGS

FIG. 1 is a schematic perspective view showing an example of basic structure of an air-packing device in the conventional technology.

FIG. 2 is a plan view showing an example of detailed structure of thermoplastic films used in the air-packing device in the area of the check valve.

FIG. 3 is a schematic diagram showing an example of process and structure for producing air-packing devices in the conventional technology.

FIGS. 4A-4C are schematic diagrams showing a process in the main heat-sealing stage in the conventional technology for explaining problems involved in the film feeding method using a belt conveyer.

FIGS. 5A-5C are schematic diagrams showing examples of structure and materials of thermoplastic films for producing air-packing devices. FIG. 5A is a perspective view showing first and second air-packing films and a check valve film, FIG. 5B is a cross sectional view showing a structure of the thermoplastic films of FIG. 5A each incorporating a nylon film, and FIG. 5C is a cross sectional view showing a structure of the thermoplastic films of FIG. 5A without incorporating a nylon film.

FIGS. 6A-6B are schematic diagrams showing an example of structure of the first production system for performing a heat-sealing process for producing air-packing devices in the present invention, where FIG. 6A is a plan view thereof and FIG. 6B is a front view thereof.

FIGS. 7A-7C are schematic diagrams showing an example of structure of the second production system for performing a post heat-healing process for producing air-packing devices in the present invention, where FIG. 7A is a plan view thereof, FIG. 7B is a front view thereof, and FIG. 7C is a left side view thereof.

FIG. 8 is a plan view showing an example of sheet like structure of the air-packing device before folding and applying a post heat-sealing process for creating generally square shape of the air packing device of FIG. 10.

FIGS. 9A and 9B are schematic diagrams showing the air-packing device 80 which is folded for the post-heat sealing process by the second production system of FIGS. 7A-7C, where FIG. 9A is a plan view thereof, and FIG. 9B is a side view thereof.

FIG. 10 is a perspective view showing an example of structure of the air-packing device which corresponds to that of FIGS. 8 and 9A-9B to be produced by the production method and system of the present invention.

FIG. 11 is a schematic front view showing an example of structure of the heat-sealing stage in the production system of the present invention.

FIGS. 12A and 12B are schematic front views of the heat-sealing stage in the production system of the present invention showing an operation of the mechanism involving a high heat resistance film.

FIGS. 13A-13C are timing charts showing a timing relationship among the operations of heating the thermoplastic films, reverse feeding the high heat resistance film, and the forward feeding the thermoplastic films in the production method of the present invention.

FIGS. 14A-14D are schematic diagrams showing a process of heating the thermoplastic films, reverse feeding the high heat resistance film, and the forward feeding the thermoplastic films in the production method and system of the present invention.

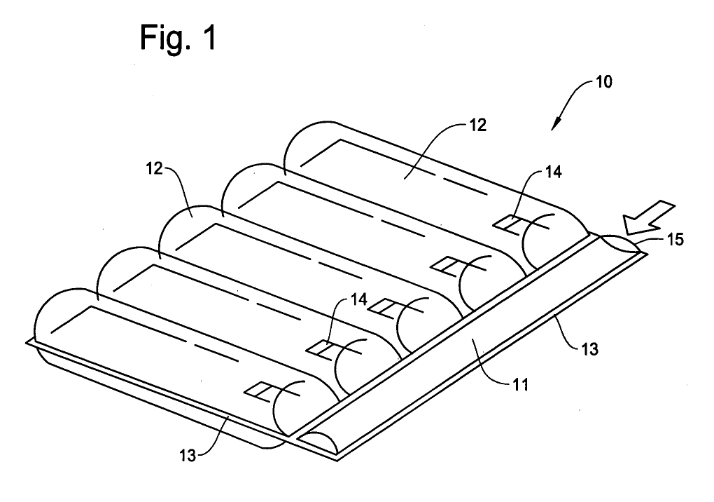

### DETAILED DESCRIPTION OF THE INVENTION

The production method and system of the present invention for producing air-packing devices will be described in more detail with reference to the accompanying drawings. It should be noted that although the present invention is described for the case of producing air-packing devices using an air for inflating for an illustration purpose, other fluids such as other types of gas or liquid can also be used. The air-packing device is typically used in a container box to pack a product during the distribution flow of the product.

The air-packing device is especially useful for packing a product which is sensitive to shock or vibration such as a personal computer, DVD driver, etc, having high precision mechanical components such as a hard disc driver. Other examples of such products include wine bottles, glassware, ceramic ware, music instruments, paintings, antiques, etc. The air-packing device reliably wraps the product within a space created by folding and applying a post heat-sealing treatment, thereby absorbing the shocks and impacts to the product when, for example, the product is inadvertently dropped on the floor or collided with other objects.

The air-packing device of the present invention includes a plurality of air containers each having a plurality of series connected air cells. Each air container is air-tightly separated from the other air containers while the air cells in the same air container are connected by the air passages. Each air cell in the air container has a sausage like shape when inflated.

More specifically, two or more air cells are connected through air passages to form a set (air container) of series connected air cells. Each set of series connected air cells has a check valve, typically at an input area to supply the air to all of the series connected air cells while preventing a reverse flow of the compressed air in the air cell. Further, two or more such sets (air containers) having series connected air cells are aligned in parallel with one another so that the air cells are arranged in a matrix manner.

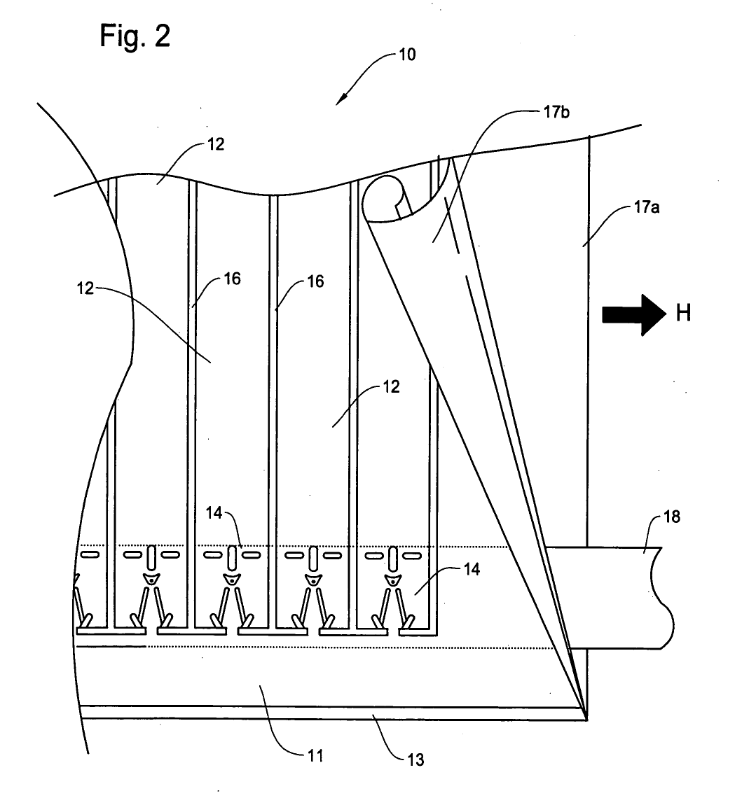

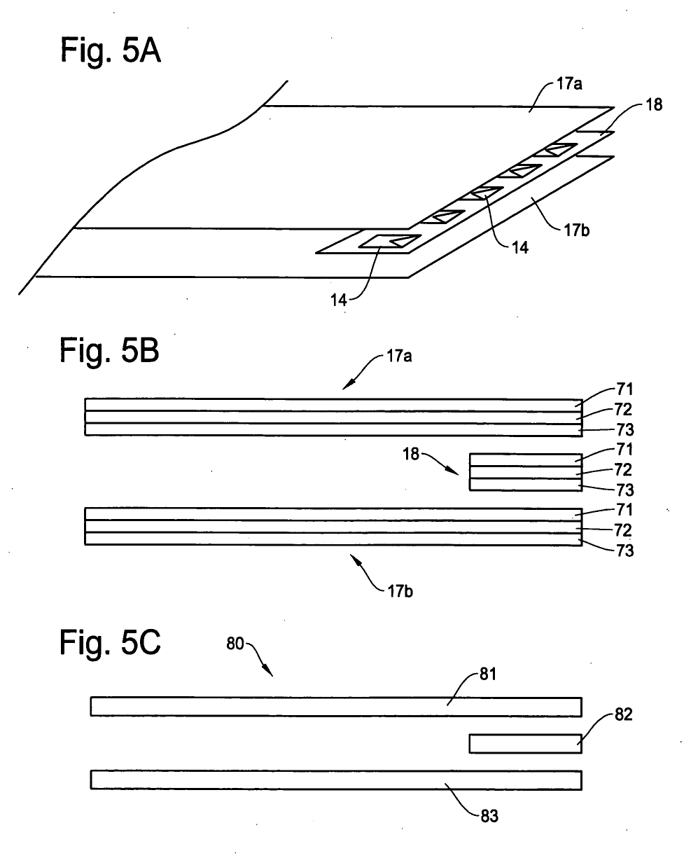

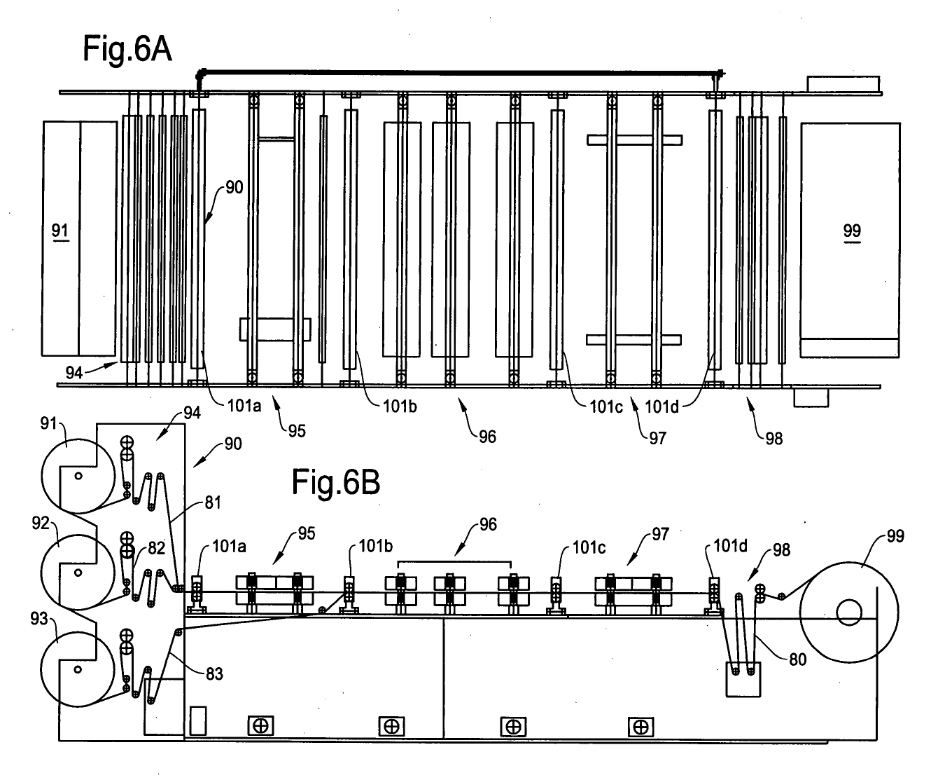

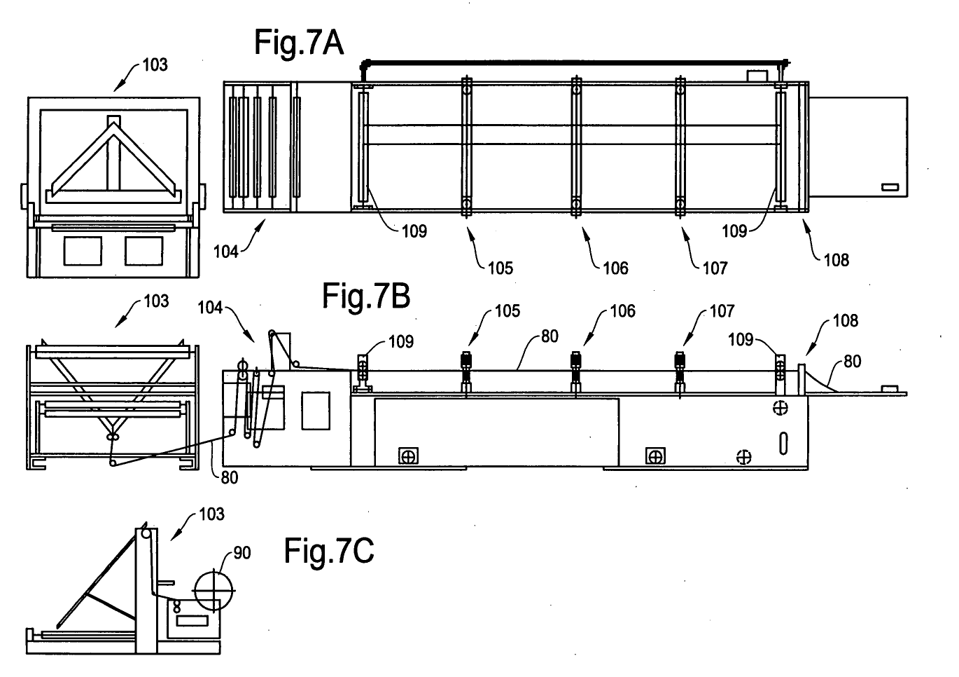

Such an air-packing device is basically made of two thermoplastic films (first and second air-packing thermoplastic films) 17a-17b and a check valve thermoplastic film 18 as shown in FIGS. 2 and 5A. The check valve film 18 having check valves 14 is placed between the first and second air-packing film 17a and 17b at a predetermined location. These thermoplastic films are heat-sealed by the production system shown in FIGS. 6A-7C to form a air-packing device having a plurality of air containers.

Further, as shown in FIG. 5B, each thermoplastic film is typically formed of three layers of films, an upper film, a lower film, and an enforcement film (ex. nylon) sandwiched by the upper and lower films. For example, the first thermoplastic film 17a is configured by an upper thermoplastic film 71, an enforcement (nylon) film 72, and a lower thermoplastic film 73 adhered to one another. Each of the second thermoplastic film 17b and the check valve film 18 is also configured by the same manner.

In this structure of the thermoplastic film, the enforcement film typically made of nylon is used to increase the physical strength of the thermoplastic film. However, the thermoplastic film is costly because it uses the enforcement (nylon) film and the three layers of films have to be adhered to one another. Therefore, it is desired that each thermoplastic film is configured without using an enforcement film as shown in FIG. 5C. The example of FIG. 5c is configured by single layer of thermoplastic films, i.e., first air-packing film 81, a check valve film 82, and a second air-packing film 82.

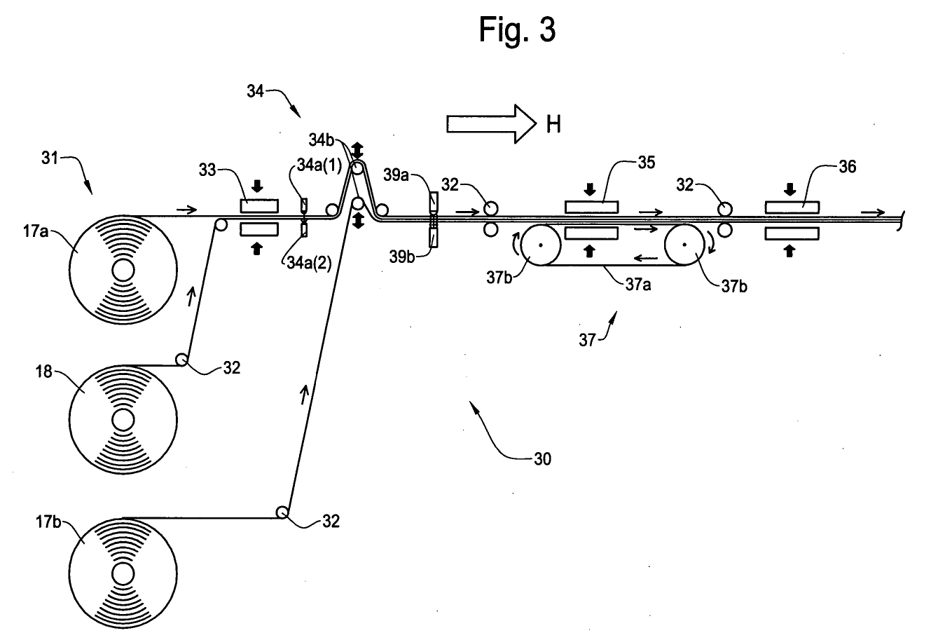

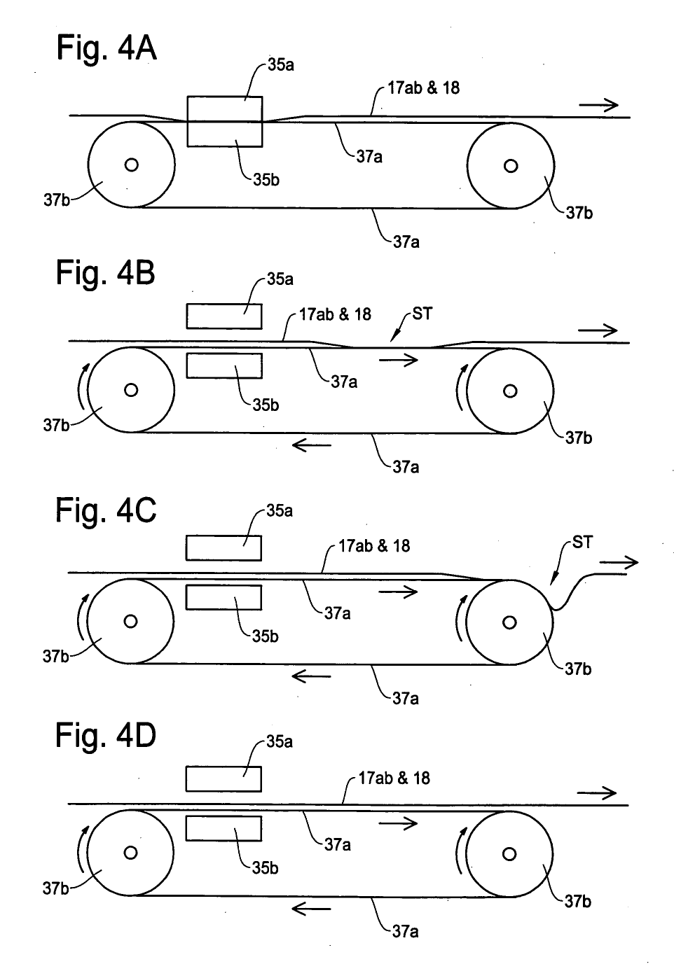

The thermoplastic films of FIG. 5C without using the nylon film can dramatically decrease its cost, although its mechanical strength will be decreased as well. As noted above with reference to FIGS. 3 and 4A-4D, the conventional production apparatus causes a large stress to the thermoplastic films. Namely, in the heat-seal stage using the belt conveyer between the heater and the thermoplastic films, a large pulling force is applied to the heat-sealed portions of the thermoplastic films when the thermoplastic films are separated from the belt conveyer.

The production system of the present invention is designed to produce the air-packing devices using single layer of thermoplastic films or conventional thermoplastic films including nylon films. An example of the production system of the present invention is shown in FIGS. 6A-6B and 7A-7C. FIGS. 6A and 6B are schematic diagrams showing an example of first production system for performing the heat-sealing processes. FIGS. 7A-7C are schematic diagrams showing an example of second production system for performing a folding process and a post heat-healing process after the heat-sealing process by the first production system of FIGS. 6A-6B. The essential feature of the present invention resides in the heat-seal process conducted by the first production system.

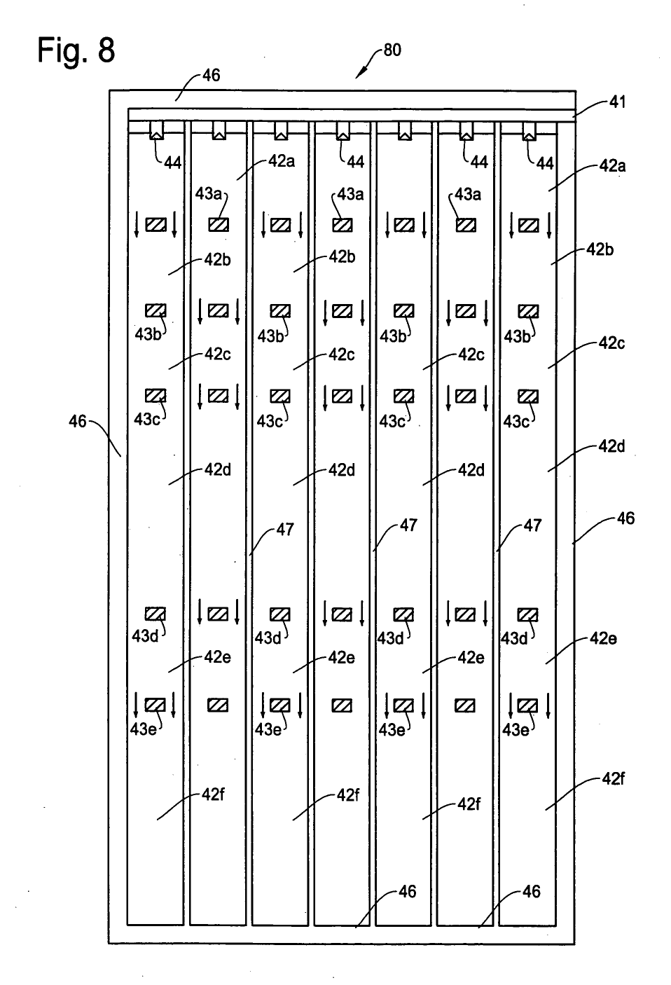

FIG. 6A is a schematic plan view of the first production system and FIG. 6B is a schematic front view of the first production system. The first production system is to produce the air-packing devices by heat-sealing the thermoplastic films in a sheet like form of FIG. 8. The second production system of FIG. 7A-7C is to fold the air-packing device in the sheet like form produced by the first production system. The second production system also heat-seals the predetermined locations of the air-packing device to create a three dimensional form of the air-packing device such as shown in FIG. 10 (when inflated).

The first production system of FIG. 6A and 6B is basically configured by a film supply section 90, a first heat-seal stage 95, a second heat-seal stage 96, a third heat-seal stage 97, a feeding speed adjuster 98, film feeders 101a-101d, and a film roller 99. The film supply section 90 includes film rollers 91-93 for supplying first and second thermoplastic films 81, 83 and a check valve film 82 to the heat-seal stages 95-97. Although not shown, the first and second production systems include various sensors to detect and adjust the position of the thermoplastic films. The thermoplastic films 81-83 are repeatedly stopped at the heat-seal stages and moved forward to the next heat-seal stages.

The film supply section 90 includes feeding speed adjuster 94 for adjusting the feeding speed of the film rollers 91-93 and the heat-seal stages 95-97. The film roller 99 is to roll the heat-sealed thermoplastic films for the process of the second production system. The feeding speed adjuster 98 is to adjust the feeding speed of the film roller 99 and the heat-seal stages 95-97. The film feeders 101a-101d are provided to send the thermoplastic films 81-83 forward in the feeding direction. The film feeder 101a also functions to superpose the first thermoplastic film 81 and the check valve thermoplastic film 82. The film feeder 101b also functions to superpose the first thermoplastic film 81 and the second thermoplastic film 83 while sandwiching the check valve thermoplastic film 82 therebetween.

Since the rollers 91-93 rotate continuously at the same speed for outputting the thermoplastic films 81-83, but the thermoplastic films 81-83 have to stop repeatedly at the heat-seal stages 95-96, the film feed speed adjuster 94 adjusts the film feeding speed therebetween. Similarly, since the roller 99 rotates continuously at the same speed, but the thermoplastic films 81-83 have to stop repeatedly at the heat-seal stages 95-96, the film feed speed adjuster 98 adjusts the film feeding speed therebetween.

The first heat-seal stage 95 is to bond the first (air-packing) thermoplastic film 81 and the check valve thermoplastic film 82 by heating the films. This is done by superposing a check valve film 82 on the first air-packing thermoplastic film 81, and bonding the check valve thermoplastic film 82 to the first air-packing thermoplastic film 81 by heating the thermoplastic films by a heater in the first heat-seal stage 95. As a result, a plurality of check valves are created for each air container of the air-packing device.

The second heat-seal stage 96 is to bond the first (air-packing) thermoplastic film 81 and the second (air-packing) thermoplastic film 83 at predetermined bonding areas such as edges 46 and boundaries 47 of FIG. 8 by heating the films. This is done by superposing the second air-packing thermoplastic film 83 on the first air-packing thermoplastic film 81 while sandwiching the check valve film 82 therebetween, and bonding the first air-packing thermoplastic film and the second air-packing thermoplastic film by heating the thermoplastic films by a heater in the second heat-seal stage 96. Thus, a plurality of air containers are created where the check valve is provided for each air container.

The third heat-seal stage 97 is to bond the first air-packing thermoplastic film 81 and the second air-packing thermoplastic film 83 at predetermined bonding areas such as heat-seal lands 43a-43e of FIG. 8 by heating the films. In the case where the second heat-seal stage 96 is designed to also perform the heat-seal step to create the heat-seal lands, the third heat-seal stage 97 will be unnecessary. As will be described in detail later, a heat resistant film provided between the thermoplastic films and the heater is moved in a direction opposite to the feeding direction of the thermoplastic film immediately after each bonding step before moving the thermoplastic films forward in the feeding direction.

After the heat-seal processes by the first production system of FIGS. 6A-6B, the air-packing devices 80 in the sheet like form of FIG. 8 is continuously produced which is rolled on the film roller 99. The sheet of air-packing devices is processed by the second production system of FIG. 7A-7C. The second production system is to fold the air-packing device and to apply post heat-seal process to the folded air-packing devices to create a container or a wrapping area for covering a product to be protected.

Since the features of the present invention reside mainly in the heat-seal process conducted in the first production system, the second production system will be explained only briefly below. The air-packing devices 80 created by the first production system is rolled on the film roller 99 and is further processed by the second production system. The second production system is configured by a film folding section 103, a feeding speed adjuster 104, heat-seal stages 105-107, film feeders 109, and a film cutter 108.

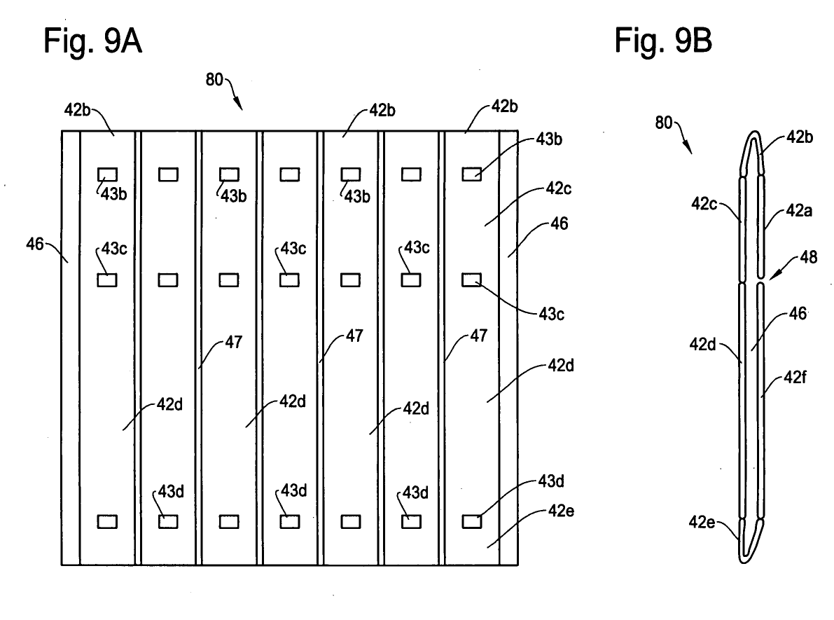

The film folding section 103 folds the air-packing devices 80 on the film roller 99 in a predetermined shape such as shown in FIGS. 9A and 9B. The film folding section 103 sends the folded air-packing devices 80 to the heat-seal stages 105-107 through the feeding speed adjuster 104. The feeding speed adjuster 104 adjusts the difference in the feeding speed between the film folding section 103 and the heat-seal stages 105-107. The film cutter 108 cuts the continuous films of air-packing devices to separate air-packing devices 80. The heat-seal stages 105-107 are provided to bond the predetermined portions of the air-packing device after being folded such as side edges 46 of FIG. 9A to create a container (wrapping) shape of the air-packing device 80. The film feeders 109 are provided to move the heat-sealed air-packing devices 80 forward.

FIG. 8 is a plan view showing an example of sheet like structure of the air-packing device 80 created by the first production system of FIG. 6A-6B. Before folding and applying a post heat-sealing process, the air-packing device 80 is a flat sheet like form. It should be noted that, although only one air-packing device 80 is shown in FIG. 8, a large number of air-packing devices 80 are integrally rolled on the film roller 99 at the end of the heat-seal processes of the first production system.

The example of FIG. 8 is a sheet of air-packing device for creating a generally square shape of the air-packing device of FIG. 10. As will be described later, the air-packing device of FIG. 10 has a slit for loading a product there through formed by an upper end and a lower end, i.e., two longitudinal ends of the air-packing device 80 of FIG. 8. Such a loading slit can be established on an upper (or lower) surface of the air-packing device 80 of FIG. 10 by not heat-sealing the upper and lower ends in the post heat-seal process.

As shown in FIG. 8, the air-packing device 80 has many sets of air containers each having a check valve 44 and series connected air cells 42a-42f. An air input 41 is commonly connected to all of the check valves 44 so that the air is supplied to each set of air cells 42a-42f through the check valve 44. Between the two air cells 42a-42f connected in series, heat-seal lands 43 are formed where the thermoplastic films are bonded together. Thus, when inflated, each of the air cells 42a-42f creates a sausage like shape in the manner shown in FIG. 10, which facilitates to bend the air-packing device 80.

As noted above, the air-packing device 80 is composed of first and second thermoplastic films and a thermoplastic check valve film. Each of the thermoplastic films is composed of three layers of materials: polyethylene, nylon and polyethylene which are bonded together with appropriate adhesive. Alternatively, each of the thermoplastic film is made of a single layer of plastic film, such as a polyethylene film, without using an enforcement film such as a nylon film. The first and second thermoplastic films 81 and 83 are heat-sealed together at the outer edges 46 and each boundary 47 between two sets of air cells after the check valve film 82 is bonded to the first thermoplastic film 81. As noted above, the first and second thermoplastic films 81 and 83 are also heat-sealed together at the locations (heat-seal lands) 43a-43e.

Thus, the heat-seal lands 43a-43e close the first and second thermoplastic films at their locations but still allow the air to pass toward the next air cells as shown by the arrows at both sides of each heat-seal land 43. Since the portions at the heat-seal lands 43 are closed, as noted above, each air cell 42 is shaped like a sausage when inflated. In other words, the air-packing device 80 can be easily bent or folded at the heat-seal lands 43 to create the shape that fits to the product to be protected.

FIGS. 9A and 9B are schematic diagrams showing an air-packing device which is folded for a post heat sealing process for forming the air-packing device of FIG. 10 from the sheet like shape of FIG. 8. FIG. 9A is a plan view of the air-packing device 80 when folded by the second production system, and FIG. 9B is a side view of the air-packing device 80 of FIG. 9A. The post heat-seal process is applied to the folded air-packing device by the second production system to create a three dimensional structure when inflated having a container portion for loading the product to be protected as shown in FIG. 10.

The flat sheet of air-packing device 80 in FIG. 8 is folded as shown in FIGS. 9A and 9B and is undergone the post heat-seal process for forming the air-packing device of FIG. 10. In this example, the sheet form of the air-packing device 80 is folded in half and the edges 46 are bonded together at each side by the heat-seal stages of the second production system of FIGS. 7A-7C. The upper end (edge 46) and the lower end (edge 46) of FIG. 8 are not bonded together in the post heat-seal process. Accordingly, an opening 48 (FIGS. 9B and 10) is created which functions as a loading slit for introducing the product.

FIG. 10 is a perspective view showing an example of structure of the air-packing device 80 in the resent invention corresponding to FIGS. 8 and 9A-9B. The air-packing device 80 of FIG. 10 is formed by supplying the air after the folding and post heat-sealing process of FIGS. 9A-9B by the second production system of FIGS. 7A-7C. The air-packing device 80 has an inner space for packing a product therein and an opening 48 which is a slit for loading the product therethrough. As noted above, the opening 48 is created by not heat-sealing the upper and lower ends of FIG. 8. In the example of FIG. 10, the opening 48 is established on the upper (or lower) surface of the air-packing device 80.

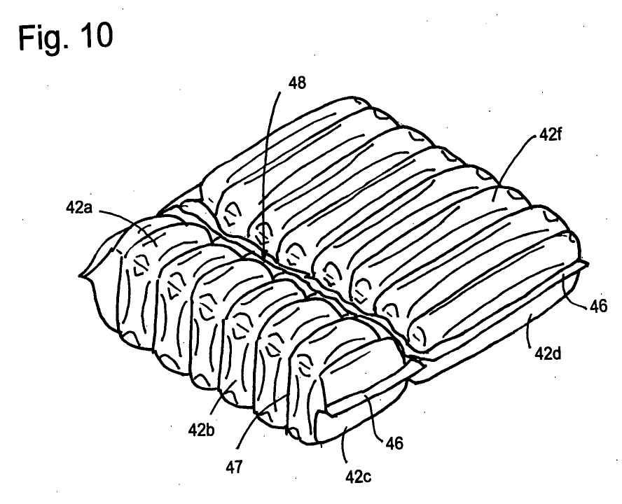

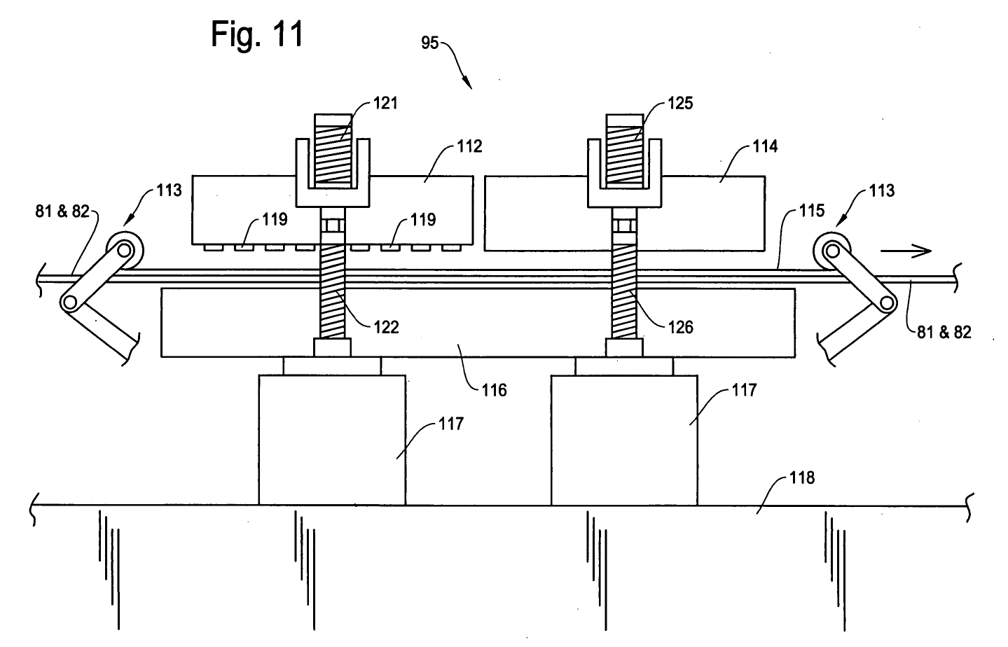

FIG. 11 is a schematic front view showing an example of structure of the heat-seal stage in the production system of the present invention. Since the heat-seal stages 95-97 have basically the same structure, the structure and operation of only the heat-seal stage 95 is described here with reference to FIG. 11. The heat-seal stage 95 is to bond the thermoplastic film (first air-packing film) 81 and the check valve film 82. The heat-seal stage 95 is formed on a frame 118 of the first production system and is composed of a heater 112, a cooler 114, a base 116, a Teflon tape drive mechanism 113, springs 121, 122, 125 and 126, and supports 117.

The heater 112 has heater heads 119 which are formed of a pattern unique to the particular air-packing device to be produced for bonding the thermoplastic films 81 and 82 at the predetermined locations when the heater 112 is pressed down on the base 116. The cooler 114 is formed next to the heater 112 to cool the thermoplastic films 81 and 82 heated by the heater 112 in the previous heat-seal step. Although not shown, the cooler 114 has a cavity which is provided with cooling water or other cooling fluids to maintain low temperature to efficiently cool the thermoplastic films 81-83. The Teflon tape drive mechanism 113 is to drive a Teflon tape (film) 115 or other high heat resistant film such as a Mylar film inserted between the heater 112 (heater heads 119) and the thermoplastic films 81-83. If the heater heads 119 directly contact with the thermoplastic films, the parts of the films that have contacted with the heater heads 119 will be melted and damaged. Thus, the Teflon tape 115 is inserted to protect the thermoplastic films 81-83.

When the heater 112 is moved up and down by a drive mechanism such as a motor (not shown), the springs 121 and 122 assist the up/down movement of the heater 112. Similarly, when the cooler 114 is moved up and down by a drive mechanism such as a motor (not shown), the springs 125 and 126 assist the up/down movement of the cooler 114. Although this example shows the case where the heater 112 is moved up and down, it is also possible to design so that the base 116 is moved up and down. Further, although this example shows the case where the heater 112 is positioned over the thermoplastic films 81 and 82, it is also possible to reverse this relationship. Thus, the heater 112 can be positioned under the thermoplastic films 81 and 82 and press the thermoplastic films upwardly for heat-sealing.

In FIG. 11, when the thermoplastic films 81 and 82 come to the predetermined position under the heater 112 and the cooler 114, the heater 112 and the cooler 114 move downward and press the thermoplastic films 81 and 82 on the base 116. After predetermined time, the heater 112 and cooler 114 move upward, and the thermoplastic films 81 and 82 are moved forward. Typically, the thermoplastic films 81 and 82 are moved forward by the length of one air-packing device 80 and stopped for the heat-seal process of the next air-packing device 80.

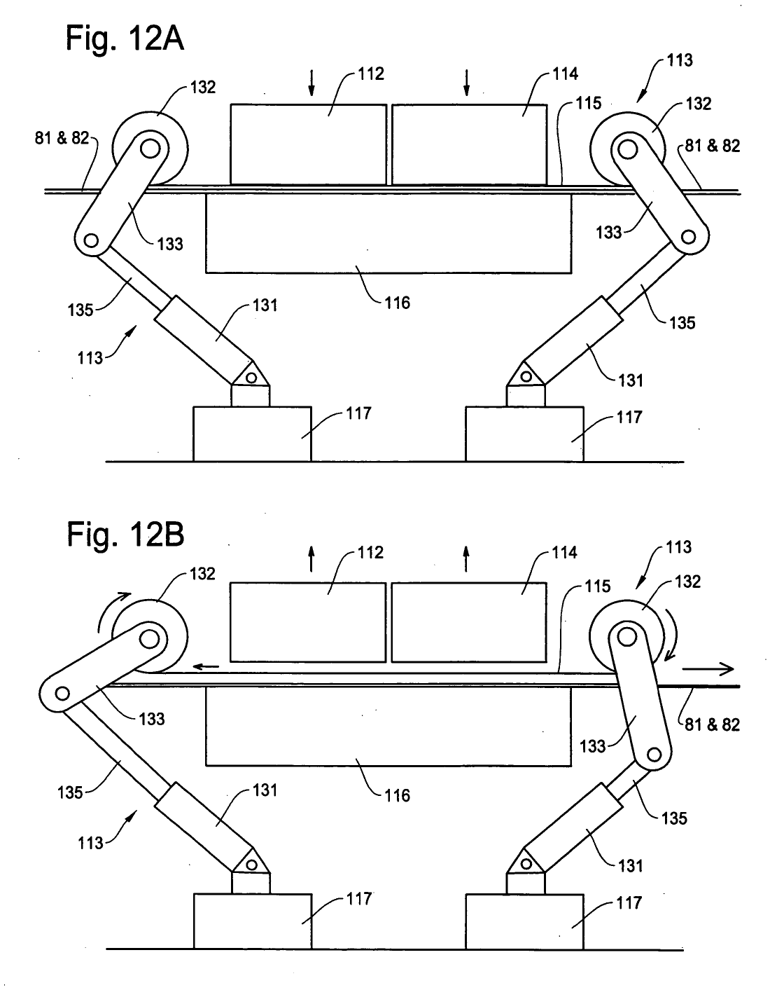

FIGS. 12A and 12B are schematic diagram showing the operational relationship among the heater 112 (and cooler 114), the Teflon tape drive mechanism 13, and the movement of the thermoplastic films 81 and 82. In this example, the heater 112 and the cooler 114 are driven in the same direction by the same timing, although different movements are also possible. FIG. 12A shows a situation where the heater 112 and the cooler 114 press the thermoplastic films 81 and 82 on the base 116, and FIG. 12B shows a situation where the heater 112 and the cooler 114 are released so that the thermoplastic films 81 and 82 move forward after the Teflon tape (film) 115 is slightly moved backward.

The Teflon tape drive mechanism 113 is illustrated in detail in FIGS. 12A and 12B. The Teflon tape drive mechanism 113 is a pair of mechanisms for driving the Teflon tape 115 in the backward direction immediately after the thermoplastic films 81 and 82 are heated and returning to the original position. Each Teflon tape drive mechanism 113 is configured by a tape roller 132, an arm 133, a cylinder rod 135, and an air cylinder 131.

The air cylinder 131 either extends or contracts the cylinder rod 135 in response to a control signal, which pivots the arm 133 and the tape roller 132. The tape rollers 132 support the Teflon tape 115 with a predetermined tension from the left and right side of the heater 112 and the cooler 114. The Teflon tape 115 is inserted between the heater 112 (cooler 114) and the thermoplastic films 81 and 82 to prevent the heater heads 119 from directly contacting the surfaces of the thermoplastic films 81 and 82 during the heat-sealing process. Thus, when the air cylinders 131 are driven by the control signals, the Teflon tape 115 moves either backward or forward depending on the direction of the rotation of the tape rollers 132.

Prior to the heater 112 and the cooler 114 move downward to press the thermoplastic films 81 and 82, the Teflon tape drive mechanism 113 is returned to the normal position in FIG. 12A. Then, the heater 112 and the cooler 114 press the thermoplastic films 81 and 82 so that the thermoplastic films 81 and 82 heated by the heater 112 are bonded at the locations defined by the heater heads 119 (FIG. 11). At the same time, the cooler 114 cool down the thermoplastic films 81 and 82 heated by the heater 112 in the previous heat-seal step.

After the predetermined heat-seal time, the heater 112 and the cooler 114 move upward to release the thermoplastic films 81 and 82 as shown in FIG. 12B. At this moment, because the thermoplastic films 81 and 82 have been heated, they are stuck to the Teflon tape 115. Immediately after the upward movement of the heater 112 and cooler 114, or at the same time as this upward movement, the Teflon tape drive mechanism 113 drives the Teflon tape 15 to move backward in a small degree. This is done by rotating the tape roller 132 in the direction designated by the arrows by operating the air cylinders 131.

Consequently, the Teflon tape 115 is separated from the heated thermoplastic films 81 and 82. Immediately after this backward movement of the Teflon film 115, the thermoplastic films 81 and 82 are moved forward by the length corresponding to one air-packing device. Because of the operation of the Teflon tape drive mechanism 113, the Teflon tape 115 and the thermoplastic films are separated relatively easily without causing damages on the thermoplastic films. Then, the Teflon tape drive mechanism 113 drives the Teflon tape 15 in the forward direction to return to the normal position for the next heat-seal step as shown in FIG. 12A.

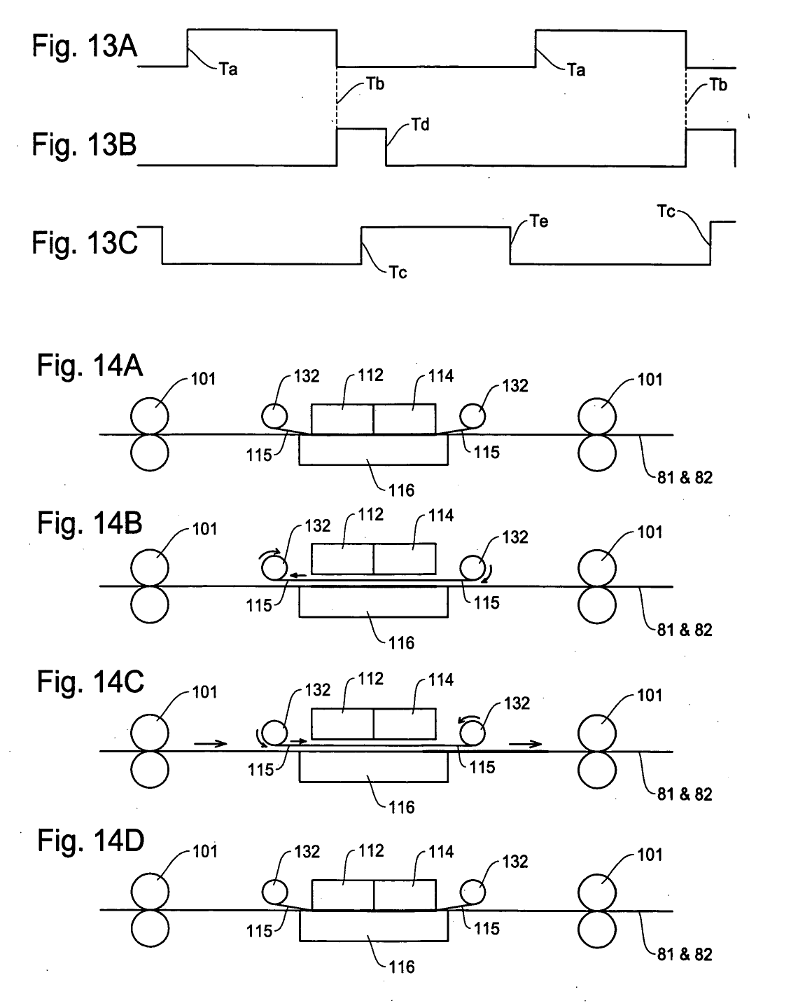

FIGS. 13A-13C are timing charts showing an example of timing relationship among the movements of the heater 112 (cooler 114), the Teflon tape drive mechanism 113, and the thermoplastic films described with reference to FIGS. 12A and 12B. The high levels in the timing charts indicate that the corresponding components are moving while the low level indicate that the corresponding components are at a standstill. FIG. 13A shows an operation timing of the heater 112, FIG. 13B shows an operation timing of the Teflon tape drive mechanism 113, and FIG. 13C shows an operation timing of the thermoplastic films 81 and 82.

After the thermoplastic films 81 and 82 are stopped at the predetermined position, the heater 112 moves down at time Ta and heat the thermoplastic films 81 and 82 as in FIG. 13A. After the predetermined heat-seal period, i.e., the thermoplastic films 81 and 82 are bonded together, the heater 112 moves upward at time Tb. As noted above, after the heat-seal step, the thermoplastic films 81 and 82 are also lightly stuck to the Teflon tape 115. At the same time or immediately thereafter the time Tb, the Teflon tape drive mechanism 113 moves the Teflon tape 115 backward as shown in FIG. 13B in a short distance while the thermoplastic films 81 and 82 are stationary.

Thus, the Teflon tape 115 is separated from the thermoplastic films 81 and 82. The backward movement of the Teflon tape 115 ends in a short period of time at Td (FIG. 13B) because only a short distance of the movement is sufficient. As shown in FIG. 13C, at time Tc, the thermoplastic films 81 and 82 are moved forward by the length determined by the size of one air-packing device for the next heat-seal step. The forward movement of the thermoplastic films ends at time Te in FIG. 13C. The above operations will be repeated by the first production system of FIGS. 6A and 6B.

FIGS. 14A-14D are schematic diagrams further showing the operations of the heater 112 (cooler 114), the Teflon tape drive mechanism 113, and the thermoplastic films 81 and 82. In the step of FIG. 14A, the thermoplastic films 81 and 82 are stopped at a predetermined location on the base 16 and the Teflon tape drive mechanism 113 is returned to the normal position. Then, the heater 112 and the cooler 114 move downward to press the thermoplastic films 81 and 82. Accordingly, the portions of the thermoplastic films contact with the heater heads 119 (FIG. 11) are bonded, thereby attaching the check valve film 82 to the first air-packing film 81. At the same time, the cooler 114 cools down the thermoplastic films 81 and 82 heated by the heater 112 in the previous heat-seal step.

In FIG. 14B, after the predetermined heat-seal time, the heater 112 and the cooler 114 move upward to release the thermoplastic films 81 and 82. At the same time or immediately after the upward movement of the heater 112 and cooler 114, the Teflon tape drive mechanism 113 drives the Teflon tape (film) 115 to move in the backward direction as shown by the arrows by rotating the tape roller 132 with the operation of the air cylinders 131. Consequently, the Teflon tape 115 is separated from the heated thermoplastic films 81 and 82. Since the thermoplastic films 81 and 82 are standstill at this moment, the force requires to separate the Teflon tape 115 from the thermoplastic films 81 and 82 is relatively small. This is because the thermoplastic films 81 and 82 are weakly adhered to the Teflon tape 115 and the force is used only for separating the thermoplastic films from the Teflon tape 115.

Immediately after this backward movement of the Teflon tape (film) 115 of FIG. 14B, the thermoplastic films 81 and 82 are moved forward by the length corresponding to one air-packing device in FIG. 14C. After the short backward movement in FIG. 14B, the Teflon tape 115 also moves forward to return to the normal position. The force required for moving the thermoplastic films 81 and 82 forward in FIG. 14C is significantly larger than the force required for separating the Teflon tape 115 from the thermoplastic films 81 and 82 in FIG. 14B, for example a ratio of 8:2. In other words, the stress applied to the thermoplastic films 81 and 82 for separating the Teflon tape 115 is small, i.e., a relative force “2” . This is an essential feature of the present invention in contrast to the large stress in the conventional technology described with reference to FIGS. 4A-4D.

In FIG. 14D, the thermoplastic films 81 and 82 is stopped for the next heat-seal step. Typically, the thermoplastic films 81 and 82 heated by the heater 112 in the step of FIG. 14A is now positioned under the cooler 114 to be cooled down. The heater 112 heats the thermoplastic films for the next air-packing device. The process of FIGS. 14A-14C will be repeated for continuously producing the air-packing devices. The same surface of the Teflon tape 115 is repeated used during the production process, however, when the Teflon tape 115 is worn or stained because of the repeated use, the rollers 132 are rotated to use a new surface of the Teflon tape 115.

As has been described above, according to the present invention, the production method and system is capable of producing the air-packing devices with high efficiency and high reliability. Since the production method and system can minimize the stress to the thermoplastic films during the heat-seal process, air-packing devices made of thermoplastic films with or without using enforcement films can be produced with high efficiency and high reliability. The size of the production system is reduced by eliminating the belt conveyers from the system and incorporating a cooler adjacent to a heater at each heat-seal stage.

Although the invention is described herein with reference to the preferred embodiments, one skilled in the art will readily appreciate that various modifications and variations may be made without departing from the spirit and the scope of the present invention. Such modifications and variations are considered to be within the purview and scope of the appended claims and their equivalents.

What is claimed is:

1. A method of producing air-packing devices, comprising the following steps of:
superposing a check valve thermoplastic film on a first air-packing thermoplastic film;
bonding the check valve thermoplastic film to the first air-packing thermoplastic film for creating a plurality of check valves by heating the thermoplastic films by a first heater;
superposing a second air-packing thermoplastic film on the first air-packing thermoplastic film while sandwiching the check valve thermoplastic film therebetween; and
bonding the first air-packing thermoplastic film and the second air-packing thermoplastic film by heating the thermoplastic films by a second heater, thereby creating a plurality of air containers each having a check valve;
wherein a heat resistant film provided between the thermoplastic films and the heater is moved in a direction opposite to a feeding direction of the thermoplastic films immediately after each bonding step before moving the thermoplastic films forward in the feeding direction.

2. A method of producing air-packing devices as defined in claim 1, wherein said step of bonding the two thermoplastic films includes a step of stopping the two thermoplastic films at a predetermined position and pressing the heater on the two thermoplastic films through the heat resistant film.

3. A method of producing air-packing devices as defined in claim 1, wherein said step of bonding the two thermoplastic films includes a step of stopping the two thermoplastic films at a predetermined position, moving the heater downwardly against the two thermoplastic films through the heat resistant film, and moving the heater upwardly to release the two thermoplastic films after a predetermined heat-seal time.

4. A method of producing air-packing devices as defined in claim 1, wherein said step of bonding the two thermoplastic films includes a step of stopping the two thermoplastic films at a predetermined position, moving the heater downwardly against the two thermoplastic films through the heat resistant film, and moving the heater upwardly to release the two thermoplastic films after a predetermined heat-seal time, wherein the heat resistant film is moved in the opposite direction immediately after the heater is moved upwardly.

5. A method of producing air-packing devices as defined in claim 1, wherein said heat resistant film is moved in the opposite direction in a degree sufficient to separate the heat resistant film from the thermoplastic films before moving the thermoplastic films in the feeding direction.

6. A method of producing air-packing devices as defined in claim 1, wherein said heat resistant film is returned to an original position after moving in the opposite direction and separating from the thermoplastic films by moving in the feeding direction.

7. A method of producing air-packing devices as defined in claim 1, further comprising the step of cooling the thermoplastic films heated in the bonding step performed immediately prior to the cooling step.

8. A method of producing air-packing devices as defined in claim 7, wherein said step of cooling the thermoplastic films is conducted by a cooler provided adjacent to each heater, where the heater and the cooler are driven in the same direction at the same timing with one another.

9. A method of producing air-packing devices as defined in claim 1, further comprising the step of folding the bonded thermoplastic films in a sheet form and bonding the folded thermoplastic films at predetermined points to form a shape of the air-packing device unique to a product to be packed by the air-packing device.

10. A system for producing air-packing devices, comprising:
means for superposing a check valve thermoplastic film on a first air-packing thermoplastic film;
a first heat-seal stage for bonding the check valve thermoplastic film to the first air-packing thermoplastic film for creating a plurality of check valves by heating the thermoplastic films;
means for superposing a second air-packing thermoplastic film on the first air-packing thermoplastic film while sandwiching the check valve thermoplastic film therebetween;
a second heat-seal stage for bonding the first air-packing thermoplastic film and the second air packing thermoplastic film by heating the thermoplastic films, thereby creating a plurality of air containers each having a check valve; and
a heat resistant film drive mechanism for driving a heat resistant film provided between the thermoplastic films and the heater in a direction opposite to a feeding direction of the thermoplastic films immediately after each bonding step before moving the thermoplastic films forward in the feeding direction.

11. A system for producing air-packing devices as defined in claim 10, wherein said heat-seal stage performs the bonding step when the two thermoplastic films are stopped at a predetermined position by pressing a heater against the two thermoplastic films through the heat resistant film.

12. A system for producing air-packing devices as defined in claim 10, wherein said heat-seal stage performs the bonding step when the two thermoplastic films are stopped at a predetermined position by moving a heater downwardly against the two thermoplastic films through the heat resistant film, and moving the heater upwardly to release the two thermoplastic films after a predetermined heat-seal time.

13. A system for producing air-packing devices as defined in claim 10, wherein said heat-seal stage performs the bonding step when the two thermoplastic films are stopped at a predetermined position by moving a heater downwardly against the two thermoplastic films through the heat resistant film, and moving the heater upwardly to release the two thermoplastic films after a predetermined heat-seal time, wherein the heat resistant film is moved in the opposite direction immediately after the heater is moved upwardly.

14. A system for producing air-packing devices as defined in claim 14, wherein said heat resistant film drive mechanism drives the heat resistant film in the opposite direction in a degree sufficient to separate the heat resistant film from the thermoplastic films before the thermoplastic films are moved in the feeding direction.

15. A system for producing air-packing devices as defined in claim 14, wherein said heat resistant film drive mechanism drives the heat resistant film to return to an original position after moving in the opposite direction and separating from the thermoplastic films by moving in the feeding direction.

16. A system for producing air-packing devices as defined in claim 14, further comprising a cooler for cooling the thermoplastic films heated in the bonding step performed immediately prior to the cooling step.

17. A system for producing air-packing devices as defined in claim 16, wherein said cooler for cooling the thermoplastic films is provided adjacent to each heater, where the heater and the cooler are driven in the same direction at the same timing with one another.

18. A system for producing air-packing devices as defined in claim 10, wherein said heat resistant film drive mechanism drives the heat resistant film to return to an original position after moving in the opposite direction and separating from the thermoplastic films by moving in the feeding direction.

19. A system for producing air-packing devices as defined in claim 10, wherein said heat resistant film drive mechanism is comprised of;
a pair of rollers where the heat resistant film is extended therebetween; and
a cylinder for rotating the roller to move the heat resistant film in said opposite direction or return to an original position.

20. A system for producing air-packing devices as defined in claim 10, further comprising means for folding the bonded thermoplastic films in a sheet form and bonding the folded thermoplastic films at predetermined points to form a shape of the air-packing device unique to a product to be packed by the air-packing device.
